(19) United States
(12) Patent Application Publication
(10) Pub. No.: US 2006/0087303 A1
(43) Pub. Date: Apr. 27, 2006

(54) Controller for a DC to DC converter having linear mode and switch mode capabilities

(76) Inventors: Alexandru Hartular, San Jose, CA (US); Chun Lu, San Jose, CA (US); You-Yuh Shyr, San Jose, CA (US); Constantin Bucur, Santa Clara, CA (US)

Correspondence Address: Scott R. Faber;Grossman, Tucker, Perreault & Pfleger, PLLC, 55 South Commercial Street, Manchester, NH, 03101, US

(21) Appl. No.: 11/057,913

(22) Filed: Feb. 15, 2005

Related U.S. Application Data
(60) Provisional application No. 60/622,150, filed on Oct. 26, 2004.

(51) Int. Cl. G05F 1/40

(52) U.S. Cl. 323/283

(57) ABSTRACT

A controller for a DC to DC converter. The controller may comprise linear mode circuitry and switch mode control circuitry. The linear mode control circuitry may be capable of providing a first control signal to a transistor of the DC to DC converter. The transistor may operate in a linear region in response to the first control signal to control an output voltage of the DC to DC converter. The switch mode control circuitry may be capable of providing a second control signal to the transistor of the DC to DC converter. The transistor may turn ON and OFF in response to the second control signal to control the output voltage of the DC to DC converter. One of the linear mode control circuitry and the switch mode control circuitry may be enabled to control the transistor in response to a state of an enable signal received at the controller.

### CROSS REFERENCE TO RELATED APPLICATIONS

This application claims the benefit of the filing date of U.S. Provisional Application Ser. No. 60/622,150, filed Oct. 26, 2004, the teachings of which are incorporated herein by reference.

### FIELD

This disclosure relates to DC to DC converters and in particular to controllers for DC to DC converters.

### BACKGROUND

A variety of electronic devices such as portable computers, portable phones, personal digital assistants, and other portable and non-portable electronic devices may utilize one or more DC to DC converters. DC to DC converters generally convert an input DC voltage to a regulated output DC voltage. A DC to DC converter may be utilized to serve a variety of loads within an electronic device. The load served by the DC to DC converter may vary from a relatively light load to a relatively heavy load. The distinction between a light and heavy load may vary based on a particular application, system, and/or user requirement.

Different types of DC to DC converters may be more suitable for serving light or heavy loads. A linear mode voltage regulator may be one type of DC to DC converter that is more suitable to providing power to light loads. The linear mode voltage regulator may monitor changes in output DC voltage and provide a control signal to a transistor to hold the output voltage at the desired value. One type of a linear mode voltage regulator may be a low drop output voltage regulator (LDO) that can provide power to a relatively light load with relatively little voltage drop and with a low noise output. Another type of DC to DC converter may be a switch mode DC to DC converter that holds the output voltage at a desired value by turning at least one transistor of the DC to DC converter ON and OFF. Such a switching type of DC to DC converter may provide a regulated output voltage at a relatively high efficiency when serving a heavy load.

A conventional method of serving one load that may be either a light or heavy load under differing conditions is to provide one DC to DC converter, e.g., an LDO, for serving the light loads, and to provide another separate DC to DC converter, e.g., a switching mode DC to DC converter, for serving the heavy loads and to switch over between each DC to DC converter under certain circumstances. Such a conventional method requires two DC to DC converters and additional components and pins to facilitate switching between each adding cost and complexity.

Accordingly, there is a need for a controller for one DC to DC converter to have both linear mode and switch mode capabilities.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram of a system embodiment;

FIG. 2 is a diagram of the DC to DC converter of FIG. 1;

FIG. 3 is a circuit diagram of one embodiment of the DC to DC converter of FIG. 2 including a controller of the DC to DC converter;

FIG. 4 illustrates plots of various signals of the pulse width modulation circuitry of the controller of FIG. 3;

FIG. 5 illustrates a circuit diagram of one embodiment of the driver of the pulse width modulation circuitry of the controller of FIG. 3;

FIG. 6 illustrates a circuit diagram of one embodiment of the over voltage/under voltage protection circuitry of the controller of FIG. 3;

FIG. 7 is a diagram of one embodiment for providing an enable signal to the controller of FIG. 2 or 3;

FIG. 8 is a circuit diagram of another embodiment for providing the enable signal to the controller of FIG. 2 or 3;

FIG. 9 illustrates plots showing a simulation result for the DC to DC converter of FIG. 3;

FIG. 10 is a zoomed in version of the plot of FIG. 9 during the transition from LDO mode to PWM mode;

FIG. 11 is a zoomed in version of the plot of FIG. 9 during the transition from PWM mode to LDO mode; and

FIG. 12 is a flow chart of operations consistent with an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

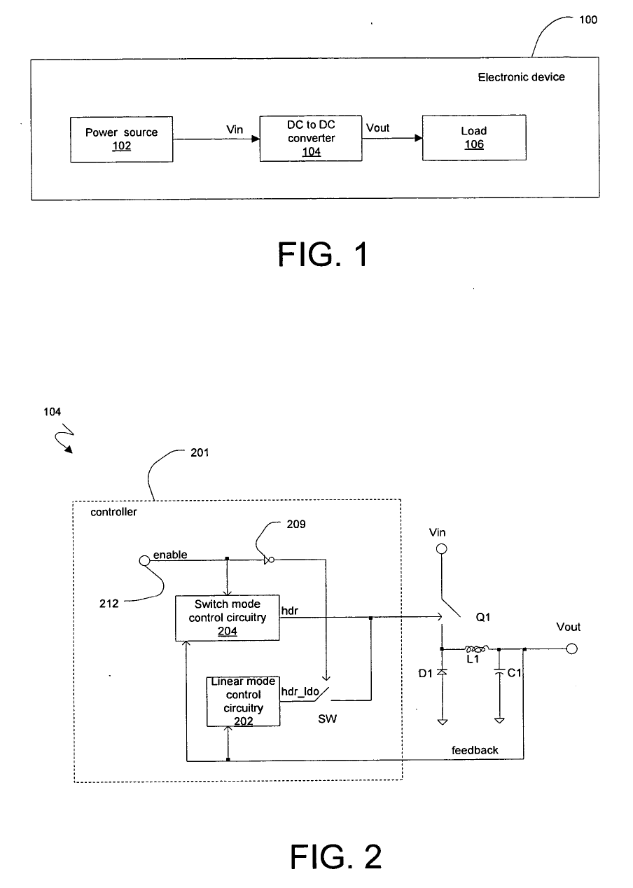

FIG. 1 illustrates a block diagram of an electronic device 100 having a power source 102, a DC to DC converter 104, and a load 106. The electronic device 100 may be a variety of devices such as a laptop computer, portable phone, personal digital assistant, and the like. The power source 102 may be any variety of power sources such as a battery, e.g., a lithium battery, for providing unregulated DC voltage (Vin) to the DC to DC controller 104. The DC to DC converter 104 may provide a regulated output DC voltage (Vout) to the load 106. Although only one DC to DC converter 104 and one associated load 106 is illustrated for clarity, the electronic device 100 may have a plurality of DC to DC converters serving any plurality of loads.

FIG. 2 is a block diagram of the DC to DC converter 104 of FIG. 1 in more detail. The DC to DC converter 104 may generally include a controller 201 for controlling the state of at least one transistor Q1 to control the output DC voltage Vout of the DC to DC converter. The transistor Q1 may be any variety of transistor types. The controller 201 may include linear mode control circuitry 202 and switch mode control circuitry 204. As used herein, “circuitry” may comprise, for example, singly or in any combination, hardwired circuitry, programmable circuitry, state machine circuitry, and/or firmware that stores instructions executed by programmable circuitry. Either the linear mode control circuitry 202 or the switch mode control circuitry 204 may control the state of the transistor Q1 of the DC to DC controller at different, non-overlapping, time intervals in response to a state of the enable signal at terminal 212.

If the enable signal is a digital zero, the switch mode control circuitry 204 may be disabled and not provide any control signal to the transistor Q1. In contrast, the linear mode control circuitry 202 may be enabled to control the state of the transistor Q1 by the closing of the switch SW in response to the digital zero enable signal. When the switch SW is closed, the linear mode control circuitry 202 may provide a first control signal, e.g., hdr_ldo, to the transistor Q1. In response to the first control signal from the linear mode control circuitry 202, the transistor Q1 may operate in a linear region and control the output voltage of the DC to DC converter. The first control signal may be an analog voltage signal.

If the enable signal is a digital one, the switch mode control circuitry 204 may be enabled to provide a second control signal to the transistor Q1. The output of the inverter 209 may now by a digital zero and the switch SW may open in response thereto. Hence, the linear mode control circuitry 202 may not be able to control the transistor Q1 in this instance. In response to the second control signal from the switch mode control circuitry 204, the transistor Q1 may turn ON and OFF to control the output voltage of the DC to DC converter. A feedback signal representative of the output voltage Vout may be provided to both the linear mode circuitry 202 and the switch mode circuitry 204 and the first and second control signals from each circuitry 202, 204 may be based at least in part on a comparison of the feedback signal with a reference voltage level.

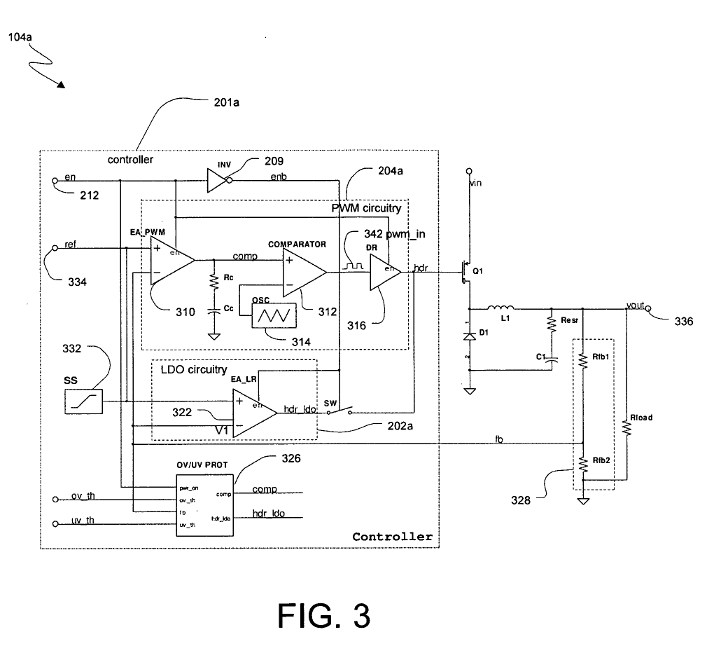

FIG. 3 illustrates an embodiment of a DC to DC controller 104a consistent with the DC to DC controller 104 of FIG. 2. The controller 201a may include low dropout voltage regulator (LDO) circuitry 202a functioning as the linear mode circuitry 202. The controller 201a may also include pulse width modulation (PWM) circuitry 204a functioning as the switch mode control circuitry 204. The PWM circuitry 204a may function as a voltage control mode asynchronous PWM controller in one embodiment as detailed in FIG. 3. In other embodiments, the switch mode control circuitry 204 may include other types of controllers including, but not limited to, a current control mode controller, synchronous controller, or pulse frequency modulation (PFM) controller. The transistor Q1 may be a p-type metal oxide semiconductor field effect transistor (MOSFET) or PMOS having its gate electrode adapted to receive the first control signal from the LDO circuitry 202a or the second control signal from the PWM circuitry 204a depending on the state of the enable signal (en).

If the enable signal is a digital zero, the PWM circuitry 204a may be disabled by placing the driver 316 in a high impedance state. The LDO circuitry 202a may also be enabled to provide its control signal (hdr_ldo) to the control terminal of PMOS transistor Q1 by the closing of the switch SW. The control signal (hdr_ldo) provided by the LDO circuitry 202a may be an analog voltage signal and the transistor Q1 may be responsive to this control signal to operate in its linear region and to conduct more or less current to adjust the output voltage level Vout. When the transistor Q1 is operating in its linear region under control of the LDO circuitry 202a, the output voltage of the DC to DC converter advantageously has an extremely low ripple voltage and the controller 201a consumes a low quiescent current.

The LDO circuitry 202a may include amplifier 322 functioning as an error amplifier. The amplifier 322 may receive a feedback signal representative of the output voltage Vout at its inverting input terminal. The feedback signal may have a voltage level V1 that may be a scaled down version of Vout as scaled down by the feedback resistive network 328 including resistors Rfb1 and Rfb2 forming a voltage divider. The amplifier 322 may also receive a reference voltage signal at its noninverting input terminal via reference terminal 334. This reference voltage signal may be provided by any variety of sources including, in one instance, a bandgap circuit.

In DC operation, the amplifier 322 of the LDO circuitry 202a may function as an error amplifier by comparing the reference voltage signal with the voltage level V1 and providing an appropriate output control signal (hdr_ldo) to the transistor Q1 via closed switch SW based on the difference between such voltage signals or a voltage error signal. The transistor Q1 may be responsive to this control signal to operated in a linear region and make any necessary adjustments to drive the voltage error signal as close to zero as possible by modifying the output voltage level Vout.

For instance, if the output voltage Vout at terminal 336 increases above a desired regulated voltage level, the feedback voltage level V1 also increases. Thus the error voltage between the inputs of the amplifier 322 would result in a control signal (hdr_ldo) that causes the transistor Q1 to conduct less current to reduce the output voltage Vout. In contrast, if the output voltage Vout at terminal 336 decreases below a desired regulated voltage level, the voltage level V1 also decreases. Thus the error voltage between the inputs of the amplifier 322 would result in a control signal (hdr_ldo) that causes the transistor Q1 to conduct more current to increase the output voltage Vout.

If the enable signal is a digital one, the driver 316 of the PWM circuitry 204a may be enabled to provide a PWM control signal (hdr) to the PMOS transistor Q1. In addition, the output of the inverter 209 may be a digital zero and the switch SW may open in response thereto to effectively prevent the control signal (hdr_ldo) from the LDO circuitry 202a from controlling the PMOS transistor. The PMOS transistor Q1 may turn ON and OFF in response to a duty cycle of the PWM control signal (hdr) to regulate the output voltage Vout. Thus the controller 201a operates as a PWM controller when the enable signal is a digital one, and the PMOS transistor Q1 operates as a switch with an ON-OFF frequency determined by the ramp signal from the oscillator 314 which can result in a high efficiency of over 90%.

The PWM circuitry 204a may include an error amplifier 310, an oscillator 314 to generate a ramp signal, a comparator 312, a compensating capacitor Cc and resistor Rc, and a driver 316. The error amplifier 310 may receive the feedback signal (fb) at its invertering input. The feedback signal may be representative of the output voltage Vout at terminal 336. The error amplifier 310 may also receive a reference voltage signal from terminal 334 at its noninverting input terminal and provide an output signal dependent on the difference. The comparator 312 may receive the comp signal at its noninverting input terminal and a ramp signal from the oscillator 314 at its inverting input terminal and provide an output PWM signal 342 (pwm_in) having a duty cycle based on the intersection of the comp signal with the ramp signal.

The controller 201a may also include over voltage/under voltage protection circuitry 326 to protect the DC to DC converter against over voltage and under voltage conditions. The controller 201a may also include soft-start circuitry 332.

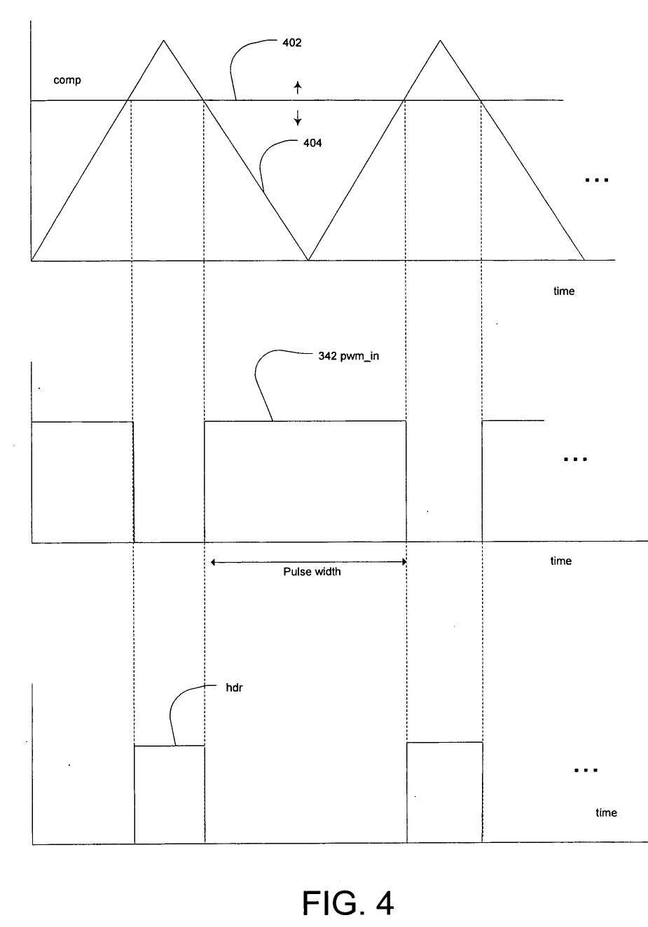

FIG. 4 illustrates the comp signal 402 input to the noninverting input terminal of comparator 312 and the ramp signal 404 (from oscillator 314 of FIG. 3) provided to the comparator 312 of FIG. 3. As the value of the comp signal 402 rises and falls, the intersection of the comp signal 402 with the ramp signal 404 changes. The resulting pwm_in signal 342 output from the comparator 312 may therefore have a pulse width and hence duty cycle dependent on the value of this intersection. As the comp signal falls, the duty cycle of the pwm_in 342 signal falls and as the comp signal rises the duty cycle of the PWM signal also rises. The driver 316 may accept this pwm_in signal 342 and provide an output PWM signal (hdr) to PMOS transistor Q1 that is the inverse of the pwm_in signal 342 as illustrated in FIG. 4.

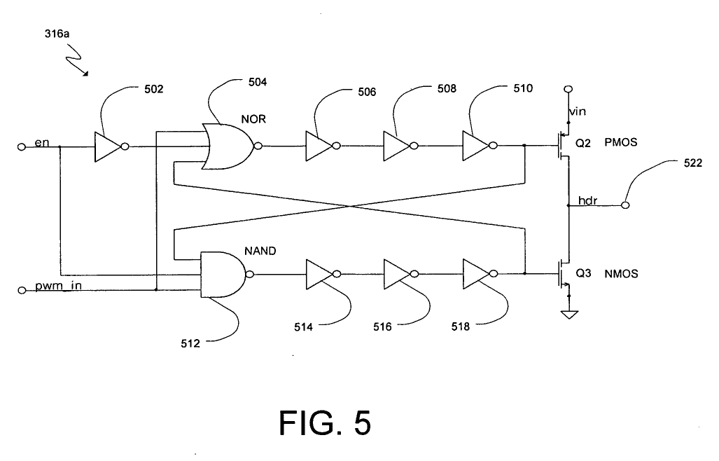

FIG. 5 illustrates an embodiment 316a of the driver 316 of the PWM circuitry 204a of FIG. 3 in more detail. The driver 316a may include a plurality of inverters 502, 506, 508, 510, 514, 516, 518, a NOR gate 504, a NAND gate 512, and transistors Q2 and Q3. Transistor Q2 may be a PMOS transistor and transistor Q3 may be an n-type metal oxide semiconductor field effect transistor (MOSFET) or NMOS.

When the enable signal is a digital zero, the output of inverter 502 may be a digital one. Since one input to the NOR gate 504 is a digital one, the output of the NOR gate 504 may be a digital zero. The output of inverter 506 may therefore be a digital one, of inverter 508 may be a digital zero, and finally of inverter 510 may be a digital one. Since transistor Q2 is a PMOS in this embodiment, transistor Q2 may be OFF in response to the digital one signal from the inverter 510. The output of the NAND gate 512 may be a digital one when the enable signal is a digital zero. The output of the inverter 514 may therefore be a digital zero, of inverter 516 may be a digital one, and finally of inverter 518 may be a digital zero. Since transistor Q3 is an NMOS in this embodiment, transistor Q3 may also be OFF and the driver 316a is effectively disabled when the enable signal is a digital zero. Since the terminal 522 of the driver 316a that provides the hdr control signal is coupled to the PMOS transistor Q2 and the NMOS transistor Q3 that are both OFF, no output signal hdr is provided by the driver 316a when the enable signal is a digital zero. As such, the driver 316a is effectively disabled. In other words, the driver 316a may effectively be in a high-impedance state when the enable signal is a digital zero.

When the enable signal is a digital one, the hdr signal may be the inverse of the pwm_in signal as illustrated in FIG. 4. The pwm_in signal may be a digital one or digital zero. When the pwm_in signal is a digital one and the enable signal is a digital one, the output of the NOR gate 504 may be a digital zero. Accordingly, the output of the inverter 506 may therefore be a digital one, of inverter 508 may be a digital zero, and finally of inverter 510 may be a digital one. In response to the digital one from the inverter 510, PMOS transistor Q2 may be OFF. When pwm_in is a digital one and the enable signal is a digital one, the three inputs to the NAND gate 512 may also be a digital one and hence the output of the NAND gate 512 may be a digital zero. This leads to the output of the inverter 518 being a digital one and hence NMOS transistor Q3 may be ON.

When the pwm_in signal is a digital zero and the enable signal is a digital one, the output of the output of the NAND gate 512 may be a digital one and hence the output of the inverter 518 may be a digital zero. In response, the NMOS transistor Q3 may be OFF. The three inputs to the NOR gate 504 may then be a digital zero in this instance. Hence the output of the NOR gate 504 may be a digital one and the output of the inverter 510 may be a digital zero. In response, the PMOS transistor Q2 may be ON. Accordingly, when the enable signal is a digital one, the hdr signal may be the inverse of the pwm_in signal as illustrated in FIG. 4 and when the enable signal is a digital zero the driver may be effectively disabled by turning OFF transistors Q2 and Q3.

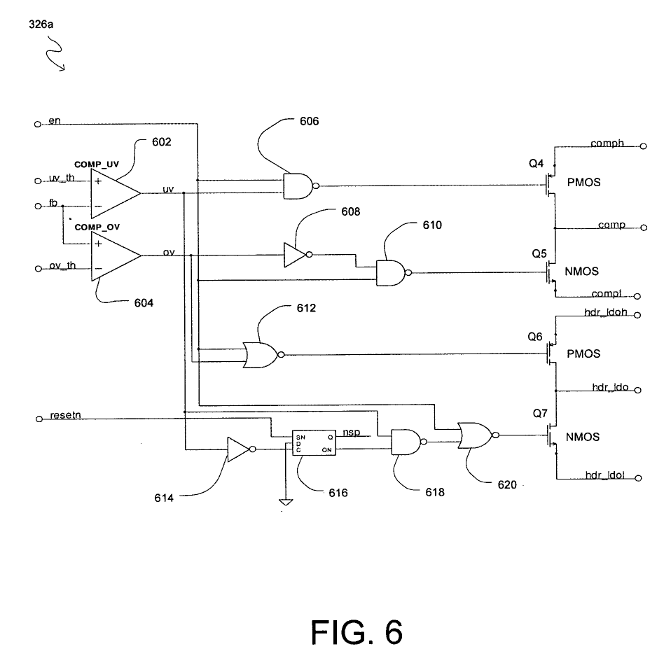

FIG. 6 illustrates an embodiment 326a of the over voltage/under voltage protection circuitry 326 of FIG. 3 in more detail. In general, if no over voltage or under voltage condition is detected, the “comp” and “hdr_ldo” signals of FIG. 3 are not compensated. If an under voltage condition is detected, the comp signal may be pulled up and the hdr_ldo signal may be pulled down to drive up the output voltage Vout. If an over voltage condition is detected, the comp signal may be pulled down and the hdr_ldo signal may be pulled up to drive down the output voltage Vout.

The over voltage/under voltage protection circuit 326a may include two comparators 602, 604. The under voltage comparator 602 may compare the feedback signal (fb) representative of the output voltage with an under voltage threshold level. If the feedback signal is not less than the under voltage threshold level, the comparator 602 may output a digital zero. If the feedback signal is equal to or less than the under voltage threshold level, the comparator 602 may output a digital one. Similarly, the over voltage comparator 604 may compare the feedback signal with an over voltage threshold. If the feedback signal is not greater than the over voltage threshold level, the comparator 604 may output a digital zero. If the feedback signal is greater than or equal to the over voltage threshold level, the over voltage comparator 604 may output a digital one.

In operation, if the enable signal is a digital one indicating use of the PWM circuitry 204a and the feedback voltage level is not less than the under voltage threshold level or greater than the over voltage threshold level, the outputs of comparators 602 and 604 would be a digital zero. Hence, the output of NAND gate 606 would be a digital one. In response, the PMOS transistor Q4 would be OFF. The output of inverter 608 would be a digital one and the output of NAND gate 610 would be a digital zero. In response, the NMOS transistor Q5 would also be OFF. Accordingly, no compensation would be applied to the comp signal in this instance.

Further in operation, if the enable signal is a digital zero indicating use of the LDO circuitry 202a and the feedback voltage level is not less than the under voltage threshold level or greater than the over voltage threshold level, the outputs of comparators 602 and 604 would still be a digital zero. Hence, the inputs to the NOR gate 612 would both be digital zero and its output would be a digital one. In response, the PMOS transistor Q6 would be OFF. The output of NOR gate 620 would be a digital zero. In response, the NMOS transistor Q7 would be OFF. Accordingly, no compensation would be applied to the hdr_ldo signal in this instance.

If the enable signal was a digital one indicating use of the PWM circuitry 204a and the feedback voltage was less than the under voltage threshold, the output of the under voltage comparator 602 would be a digital one. Since both inputs to the NAND gate 606 are a digital one in this instance, its output would be a digital zero. In response, the PMOS transistor Q4 would turn ON and pull up the comp signal to comph. By pulling up the comp signal to comph the duty cycle of the pwm_in signal would be increased to increase the output voltage level and hence the feedback voltage level.

If the enable signal was a digital one indicating use of the PWM circuitry 204a and the feedback voltage was greater than the over voltage threshold, the output of the over voltage comparator 604 would be a digital one. Hence, the output of the inverter 608 would be a digital zero. Given a digital one and digital zero input to NAND gate 610, its output would be a digital one. In response, the NMOS transistor Q5 would turn ON and pull down the comp signal to compl. By pulling down the comp signal to compl the duty cycle of the pwm_in signal would be decreased to decrease the output voltage level and hence the feedback voltage level.

If the enable signal was a digital zero indicating use of the LDO circuitry 202a and the feedback signal was greater than the over voltage threshold, the output of the over voltage comparator 604 would be a digital one. Given a digital zero and digital one input to the NOR gate 612, its output would be a digital zero. In response, the PMOS transistor Q6 would turn ON. This would pull hdr_ldo up to hdr_ldoh which in turn would pull down the output voltage Vout.

If the enable signal was a digital zero indicating use of the LDO circuitry 202a and the feedback signal was less than the under voltage threshold, the output of the under voltage comparator 602 would be a digital one. If both inputs to the NAND gate 618 were a digital one because the output QN of the D flip flop 616 was also a digital one, then the output of NAND gate 618 would be a digital zero. With both inputs to NOR gate 620 being a digital zero, the output of NOR gate 620 would be a digital one. In response, the NMOS transistor Q7 would turn ON. This would pull hdr_ldo down to hdr_ldol which in turn would pull up the output voltage Vout.

The over voltage/under voltage protection circuitry 326a can further be utilized to guarantee a smooth transition as the controller 201 transitions from the switching mode to the linear mode or from the linear mode to the switching mode. Usually during transition between the switching and linear modes, the feedback control loops acts fast enough to maintain the change in output voltage Vout within the under and over voltage thresholds. However, if the transition is accompanied by a large load transient causing the output voltage Vout to increase above the over voltage threshold or below the under voltage threshold, the controller 201 may take advantage of the over voltage/under voltage protection circuitry 326a to force the comp or hdr_ldo signal to certain voltage levels and work in a hysteresis operation mode.

The “hysteresis” concept may also be used to describe operation of a comparator. An ideal comparator may toggle when two inputs to the comparator, e.g., Vinp and Vinm are, equal. To avoid oscillation of the comparator in this instance, a “hysteresis comparator” may be utilized. The output of the hysteresis comparator may be a digital zero when the two inputs to the hysteresis comparator are equal, e.g., when Vinp=Vinm. The output of the hysteresis comparator may be a digital one when Vinp=Vinm+ΔV, where ΔV may be a small portion of Vinm.

There “hysteresis operation mode” of FIG. 6 may be somewhat similar to the operation of the hysteresis comparator. For instance, when the output voltage Vout of the DC to DC converter 104a of FIG. 3 is controlled by the over voltage/under voltage protection circuitry 326a of FIG. 6, Vout may not be equal to an ideal set value. Rather, Vout may have a non-zero peak to peak value ΔV, which may be determined by the threshold levels, uv_th and ov_th according to the equation ΔV=ov_th−uv_th.

Thus, the over voltage/under voltage protection circuitry 326a may be capable of comparing a signal representative of the output voltage of the DC to DC converter to an over voltage threshold level, e.g., by comparator 604 in the embodiment of FIG. 6. The circuitry 326a may also be capable of comparing the signal representative of said output voltage of the DC to DC converter to an under voltage threshold level, e.g., by comparator 602 in the embodiment of FIG. 6. The circuitry 326a may also be capable of driving the output voltage towards a desired output voltage level if the signal representative of the output voltage of the DC to DC converter is greater than the over voltage threshold level. The circuitry 326a may also be capable of driving the output voltage towards the desired output voltage level if the signal representative of said output voltage of the DC to DC converter is less than the under voltage threshold level to thus ensure said output voltage remains in a range defined by a difference between the over voltage threshold level and the under voltage threshold level during a transition between the linear and PWM modes.

The reset signal (resetn) may be input to the D flip-flop 616. The reset-signal may be used to avoid false under voltage situations during soft starts when the output voltage starts from about 0 volts and increases to the regulated output voltage. During such soft start condition, the initial low output voltage may otherwise trigger NMOS transistor Q7 to turn ON. The QN output of the D flip-flop may provide a digital zero in response to the reset signal such that the NAND gate 618 output is a digital one and the NOR gate 620 output is a digital zero to keep NMOS transistor Q7 OFF. Thus, the over voltage/under voltage protection circuitry 326a may be capable of identifying a soft start condition when the output voltage starts from about zero volts and increases to a desired or regulated output voltage level. The over voltage/under voltage protection circuitry 326a may also be capable of effectively disabling the comparing operation performed by the comparator 602 to avoid a false under voltage judgment during the soft start condition.

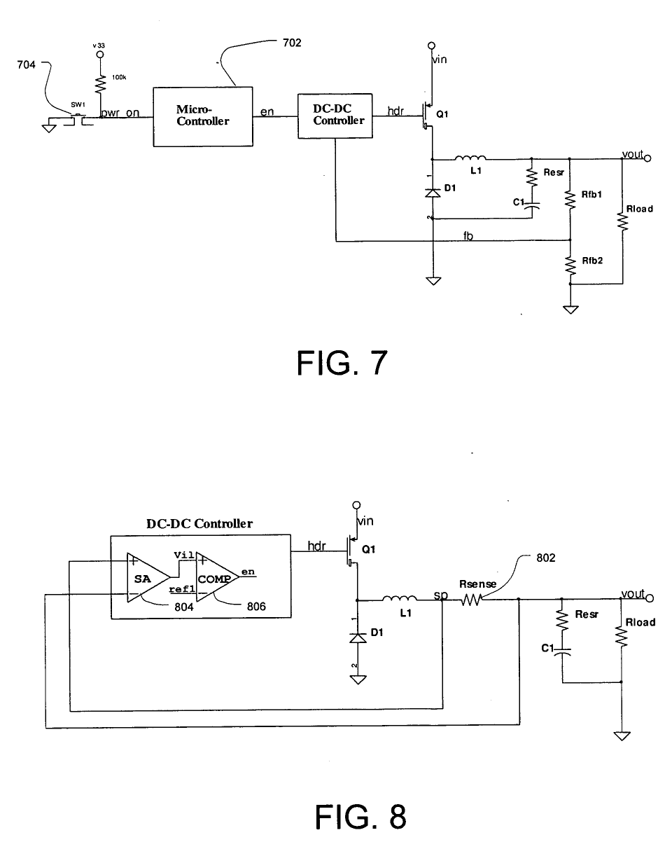

The enable signal could be provided from a variety of sources. FIG. 7 illustrates one potential source of the enable signal as a microcontroller 702. The microcontroller 702 may be powered on in portable devices once a user pushes the power on button 704.

FIG. 8 illustrates another embodiment that may provide the enable signal in response to varying load conditions. A sense resistor 802 may be utilized to sense the load current. The voltage drop across the sense resistor 802 may be proportional to the load current. Since the resistive value of the sense resistor 802 may be quite small, a sense amplifier 804 may be utilized to amplify this value to provide a voltage level representative of the load current or Vi1. A comparator 806 may then compare the voltage Vi1 with a reference voltage level ref1 and provide the enable signal in response to the comparison. When the voltage level Vi1 is greater than the reference voltage level ref1, the comparator 806 may provide an enable signal in a digital one state. When the voltage level Vi1 is less than the reference voltage level ref1, the comparator 806 may provide an enable signal in a digital zero state. In other words, when the load is a relatively heavy load, the controller may operate PWM circuitry 204a to maintain high efficiency with the heavy load. When the load is a relatively light load, the controller may operate LDO circuitry 202a to produce low noise output.

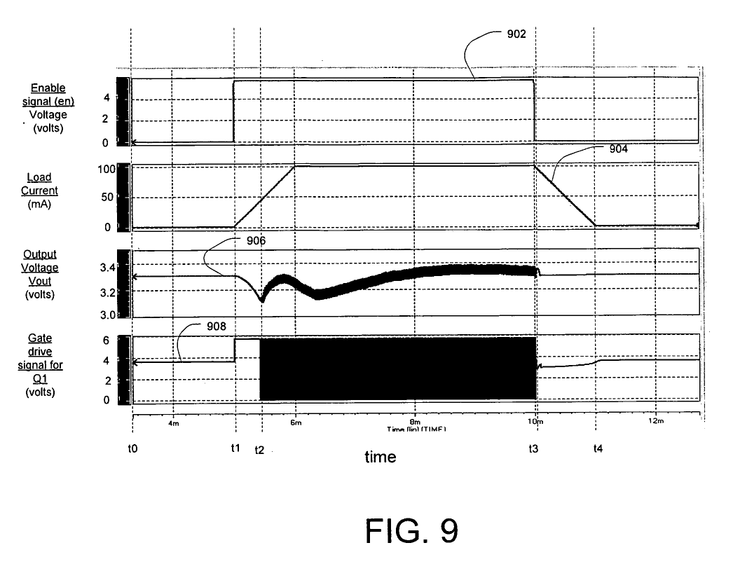

FIG. 9 shows a simulation result of the DC to DC converter 104a of FIG. 3. Plot 902 is a plot of the enable signal (en). Plot 904 is a plot of load current of the DC to DC converter changing from 1 milliamp (mA) to 100 mA. Plot 906 is a plot of the output voltage Vout of the DC to DC converter and plot 908 is a plot of the gate drive signal provided to the control terminal of PMOS transistor Q1. Between times t0 and t1, the plot 902 of the enable signal is a digital zero. Accordingly, the controller 201a is an LDO mode and LDO circuitry 202a provides the gate drive signal to the PMOS transistor Q1. During this time period between times t0 and t1, the load current remained relatively low and constant at 1 mA as indicated by plot 904. The output voltage also remained relatively constant at 3.3 volts as indicated by plot 906. Accordingly, the gate drive signal provided by the LDO circuitry 202a to the PMOS transistor Q1 as indicated by plot 908 also remained relatively constant during this time period.

At time t1, the enable signal changed from a digital zero to a digital one indicating a transition from LDO mode to a PWM mode where the PWM circuitry 204a provides the gate control signal to the PMOS transistor Q1. The comp signal which may represent the voltage level of the compensating capacitor Cc may be less than a level, e.g., 1 volt, such that the resulting duty cycle of the pwm_in signal 342 may be zero. As such, the resulting hdr signal to control the gate of PMOS transistor Q1 may be a digital one as detailed by plot 908 during the time period between times t1 and t2. Also between times t1 and t2, the output voltage may drop (plot 906) as the load current increases (plot 904).

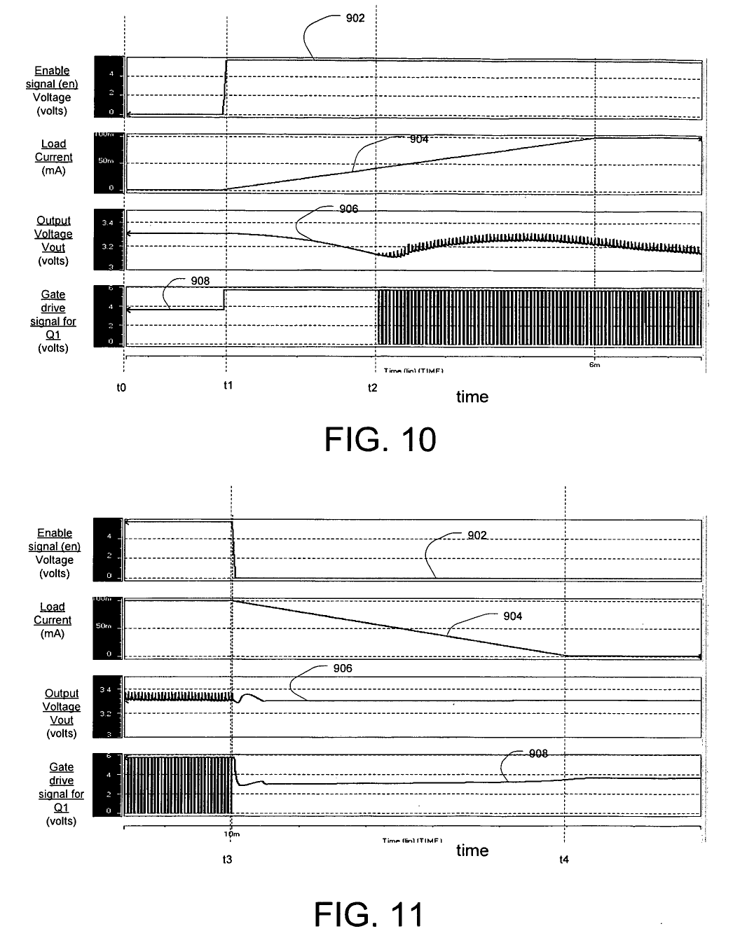

Once the comp signal reaches the threshold level, e.g., 1 volt, at time t2 the duty cycle of the pwm_in signal 342 may increase above zero and the resulting hdr signal from the driver 316 may oscillate as detailed by plot 908 between times t2 and t3 (also seen in FIG. 10). The output voltage may start to increase back to the desired value of 3.3 volts as detailed by plot 906 between times t2 and t3. The output voltage may have a ripple between times t2 and t3 due to the turning ON and OFF of the PMOS transistor Q1.

At time t3, the enable signal may transition from a digital one to a digital zero indicating a transition from PWM mode back to LDO mode where the LDO circuitry 202a provides the gate drive signal (hdr_ldo in this instance) to the PMOS transistor Q1. The gate drive signal may increase between times t3 and t4 (plot 908) as the load current decreases (plot 904) to drive the output voltage (plot 906) to its regulated value of 3.3 volts.

FIG. 10 is zoomed in version of the plots of FIG. 9 during the transition period when the controller 201a changes from LDO mode control to PWM mode control centered about time t2. FIG. 11 is another zoomed in version of the plots of FIG. 9 during the transition period when the controller changes from PWM mode to LDO mode centered about time t3.

It is known that one challenge of LDO design is loop stability over a wide range of loads currents. It may be that the LDO is stable for a light load but unstable for a heavier load. This requires compensation to be performed for the LDO which adds costs and complexity. For instance, the equivalent series resistance (Resr) of the capacitor C1 in FIG. 3 may be utilized for compensation purposes. This would then require a capacitor C1 with a well defined equivalent series resistance and would degrade the transient performance of the output voltage Vout. Other compensation solutions may also be designed which add complexity and cost to the LDO.

Table 1 indicates an example of an AC analysis of an LDO under light load (1 mA in this embodiment) and heavy load (100 mA in this embodiment) conditions. As illustrated, the phase margin of 78.5882 degrees is adequate for the light load condition but is negative for the heavy load condition. This LDO would need some compensation for the heavy load conditions for stability.

TABLE 1

| Index | iload | gain(db) | unitfreq | phasemargin | temper | alter# |
|---|---|---|---|---|---|---|
| 1 | 1 mA | 72.1337 | 1.673e+03 | 78.5882 | 60.0000 | 1.0000 |
| 2 | 100 mA | 80.7657 | 5.640e+04 | −0.9238 | 60.0000 | 1.0000 |

Advantageously, the controller 201a of FIG. 3 may operate the LDO circuitry 202a only in light load conditions and switch to PWM circuitry 204a in heavy load conditions. Therefore, the LDO circuitry 202a remains stable with little cost and complexity needed for additional compensation methods to assure stability at heavier loads and the controller 201a remains stable over a wide range of load currents.

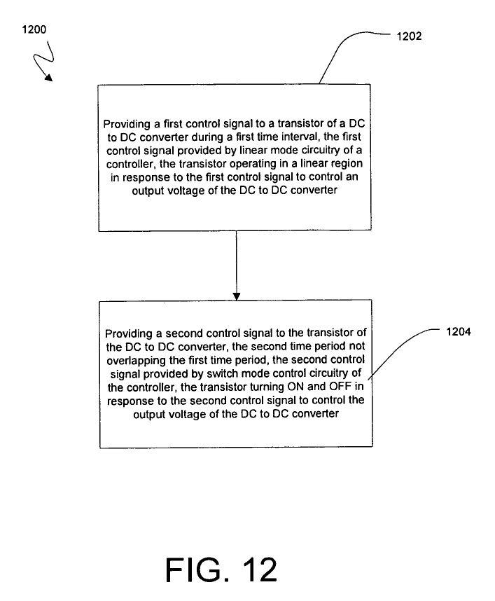

FIG. 12 illustrates operations 1200 according to one embodiment. Operation 1202 may include providing a first control signal to a transistor of a DC to DC converter during a first time period, the first control signal provided by linear mode control circuitry of a controller, the transistor operating in a linear region in response to the first control signal to control an output voltage of the DC to DC converter. Operation 1202 may include providing a second control signal to the transistor of the DC to DC converter during a second time period, the second time period not overlapping the first time period, the second control signal provided by switch mode control circuitry of the controller, the transistor turning ON and OFF in response to the second control signal to control the output voltage of the DC to DC converter.

Thus, in summary, there is provided a controller for a DC to DC converter. The controller may comprise linear mode circuitry and switch mode control circuitry. The linear mode control circuitry may be capable of providing a first control signal to a transistor of the DC to DC converter. The transistor may operate in a linear region in response to the first control signal to control an output voltage of the DC to DC converter. The switch mode control circuitry may be capable of providing a second control signal to the transistor of the DC to DC converter. The transistor may turn ON and OFF in response to the second control signal to control the output voltage of the DC to DC converter. One of the linear mode control circuitry and the switch mode control circuitry may be enabled to control the transistor in response to a state of an enable signal received at the controller.

In another embodiment, there is provided a DC to DC controller. The DC to DC controller may comprise at least one transistor and a controller to control the at least one transistor. The controller may comprise linear mode control circuitry and switch mode control circuitry. The linear mode control circuitry may be capable of providing a first control signal. The at least one transistor may operate in a linear region in response to the first control signal to control an output voltage of the DC to DC converter. The switch mode control circuitry may be capable of providing a second control signal. The at least one transistor may turn ON and OFF in response to the second control signal to control the output voltage of said DC to DC converter. One of the linear mode control circuitry and the switch mode control circuitry may be enabled to control the at least one transistor in response to a state of an enable signal received at the controller.

Advantageously, in these embodiments, one controller may be capable of operating linear mode circuitry and switch mode circuitry. Therefore, only one controller and one DC to DC converter is necessary to perform operations that conventionally required two DC to DC converters and two controllers. Hence, costs are reduced. The controller can switch between linear mode and switch mode operation in order to take advantage of the benefits of each. For instance, if the linear mode circuitry comprises LDO circuitry, the controller can operate in LDO mode during light load conditions. Hence, noise is reduced. The switch mode circuitry may comprise PWM circuitry and the controller can operate in a PWM mode to provide a PWM signal to at least one transistor of the DC to DC converter during heavier load conditions. Accordingly, high efficiency may be achieved when serving heavier loads. Furthermore, if the LDO circuitry serves only light loads, expensive and complex compensation schemes for the LDO circuitry may be avoided. Such expensive and complex compensation schemes may be necessary if the LDO circuitry serves heavier loads.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A controller for a DC to DC converter comprising:
linear mode control circuitry capable of providing a first control signal to a transistor of said DC to DC converter, said transistor operating in a linear region in response to said first control signal to control an output voltage of said DC to DC converter; and
switch mode control circuitry capable of providing a second control signal to said transistor of said DC to DC converter, said transistor turning ON and OFF in response to said second control signal to control said output voltage of said DC to DC converter, one of said linear mode control circuitry and said switch mode control circuitry being enabled to control said transistor in response to a state of an enable signal received at said controller.

2. The controller of claim 1, wherein said switch mode control circuitry comprises pulse width modulation (PWM) circuitry and said second control signal comprises a PWM signal, wherein said transistor switches ON and OFF in response to a duty cycle of said PWM signal

3. The controller of claim 1, wherein said switch mode control circuitry comprises a driver to provide said second control signal, said driver responsive to said enable signal to provide said second control signal when said enable signal is in a first state and to not provide said second control signal when said enable signal is in a second state.

4. The controller of claim 3, wherein said driver comprises a first transistor and second transistor at a final stage of said driver, said second control signal output a terminal of said driver coupled to said first and second transistor, said first and second transistor being switched OFF in response to said enable signal in said second state so that said terminal of said driver does not provide said second control signal when said enable signal is in said second state.

5. The controller of claim 1, wherein said linear mode control circuitry comprises low dropout voltage regulator circuitry and said first control signal comprises an analog voltage signal.

6. The controller of clam 5, wherein said low dropout voltage circuitry provides said analog voltage signal to said transistor when said enable signal is representative of a load current of said DC to DC converter being less than a threshold level, and wherein said switch mode control circuitry provides said second control signal to said transistor when said enable signal is representative of said load current of said DC to DC converter being greater than or equal to said threshold level.

7. The controller of claim 1, further comprising protection circuitry, said protection circuitry configured to accept a signal representative of said output voltage of said DC to DC converter and compare said signal to an under voltage threshold, said protection circuitry configured to compensate a drive signal provided to said transistor if said signal is less than said under voltage threshold, said protection circuitry also configured to compare said signal to an over voltage threshold and to compensate said drive signal provided to said transistor if said signal is greater than said over voltage threshold.

8. A DC to DC converter comprising:
at least one transistor; and
a controller to control said at least one transistor, said controller comprising:
linear mode control circuitry capable of providing a first control signal, said at least one transistor operating in a linear region in response to said first control signal to control an output voltage of said DC to DC converter; and
switch mode control circuitry capable of providing a second control signal, said at least one transistor turning ON and OFF in response to said second control signal to control said output voltage of said DC to DC converter, one of said linear mode control circuitry and said switch mode control circuitry enabled to control said at least one transistor in response to a state of an enable signal received at said controller.

9. The DC to DC converter of claim 7, wherein said switch mode control circuitry comprises pulse width modulation (PWM) circuitry and said second control signal comprises a PWM signal, wherein said at least one transistor switches ON and OFF in response to a duty cycle of said PWM signal

10. The DC to DC converter of claim 7, wherein said switch mode control circuitry comprises a driver to provide said second control signal, said driver responsive to said enable signal to provide said second control signal when said enable signal is in a first state and to not provide said second control signal when said enable signal is in a second state.

11. The DC to DC converter of claim 7, wherein said linear mode control circuitry comprises low dropout voltage regulator circuitry and said first control signal comprises an analog voltage signal.

12. The DC to DC converter of claim 8, wherein said low dropout voltage circuitry provides said analog voltage signal to said at least one transistor when said enable signal is representative of a load current of said DC to DC converter being less than a threshold level, and wherein said switch mode control circuitry provides said second control signal to said transistor when said enable signal is representative of said load current of said DC to DC converter being greater than or equal to said threshold level.

13. A method comprising:
providing a first control signal to a transistor of a DC to DC converter during a first time period, said first control signal provided by linear mode control circuitry of a controller, said transistor operating in a linear region in response to said first control signal to control an output voltage of said DC to DC converter; and
providing a second control signal to said transistor of said DC to DC converter during a second time period, said second time period not overlapping said first time period, said second control signal provided by switch mode control circuitry of said controller, said transistor turning ON and OFF in response to said second control signal to control said output voltage of said DC to DC converter.

14. The method of claim 13, wherein said switch mode control circuitry comprises pulse width modulation (PWM) circuitry and said second control signal comprises a PWM signal, wherein said transistor switches ON and OFF in response to a duty cycle of said PWM signal, and wherein said linear mode control circuitry comprises low dropout voltage regulator circuitry and said first control signal comprises an analog voltage signal.

15. The method of claim 13, further comprising:
comparing a feedback signal representative of an output current level of said DC to DC converter with a threshold level, and selecting said linear mode control circuitry to provide said first control signal to said transistor of said DC to DC converter if said feedback signal is less than said threshold level and selecting said switch mode circuitry to provide said second control signal to said transistor of said DC to DC converter if said feedback signal is greater than or equal to said threshold level.

16. The method of claim 14, further comprising disabling said switch mode control circuitry when said first control signal is selected to be provided to said transistor of said DC to DC converter.

17. The method of claim 13, further comprising:
comparing a signal representative of said output voltage of said DC to DC converter to an over voltage threshold level;
comparing said signal representative of said output voltage of said DC to DC converter to an under voltage threshold level;
driving said output voltage towards a desired output voltage level if said signal representative of said output voltage of said DC to DC converter is greater than said over voltage threshold level;
driving said output voltage towards said desired output voltage level if said signal representative of said output voltage of said DC to DC converter is less than said under voltage threshold level to thus ensure said output voltage remains in a range defined by a difference between said over voltage threshold level and said under voltage threshold level during a transition between said first time interval and said second time interval.

18. The method of claim 17, further comprising:
identifying a soft start condition when said output voltage starts from about zero volts and increases towards said desired output voltage level; and
disabling said comparing of said signal representative of said output voltage of said DC to DC converter to said under voltage threshold level to avoid a false under voltage judgment during said soft start condition.
